(19) United States
(12) Patent Application Publication
(10) Pub. No.: US 2025/0020465 A1
(43) Pub. Date: Jan. 16, 2025

(54) GYRO SENSOR

(71) Applicant: Panasonic Intellectual Property Management Co., Ltd., Osaka (JP)

(72) Inventor: Takeshi MORI, Fukui (JP)

(73) Assignee: Panasonic Intellectual Property Management Co., Ltd., Osaka (JP)

(21) Appl. No.: 18/834,885

(22) PCT Filed: Jan. 13, 2023
(86) PCT No.: PCT/JP2023/000881

§ 371 Date: Jul. 31, 2024

(30) Foreign Application Priority Data
Feb. 2, 2022 (JP) 2022-015214

(51) Int. Cl. G01C 19/5776

(52) U.S. Cl. CPC G01C 19/5776

(57) ABSTRACT

A gyro sensor includes a gyro element and a control unit. Control unit includes a drive controller and a signal processor. Drive controller generates a drive signal to input to gyro element the drive signal generated. Drive controller feedback-controls drive signal based on a drive sense signal output from gyro element. Signal processor includes an analog processor, an A/D converter, a digital calculator and a checker. Analog processor selectively outputs either a detection component or a quadrature component to A/D converter. Detection component and quadrature component are included in detection signal. Checker checks a state relating to control unit based on a first output signal or a second output signal. First output signal is output from A/D converter in response to that quadrature component is input to A/D converter. Second output signal is output from digital calculator in response to that first output signal is input to digital calculator.

### TECHNICAL FIELD

The present disclosure generally relates to gyro sensors. More particularly, the present disclosure relates to a gyro sensor having a function of checking a state of the gyro sensor itself.

### BACKGROUND ART

Patent Literature 1 discloses an acceleration sensor. The acceleration sensor includes at least one MEMS (micro mechanical sensor element) for detecting an acceleration and an evaluation unit that has redundant signal paths with one A/D converter for each sensor element. The acceleration sensor is also provided with a monitoring means for monitoring parameters related to functionality of at least one A/D converter to check validity of an output signal of the acceleration sensor. The monitoring means includes an equivalent circuit for the sensor elements integrated in the evaluation unit and a redundant additional A/D converter.

According to the acceleration sensor, substantially the same type of additional A/D converter is implemented in the evaluation unit, which can realize the redundancy related to supply or monitoring in a simplified manner.

### CITATION LIST

### Patent Literature

Patent Literature 1: JP 2015-515616 A

### SUMMARY OF INVENTION

If a gyro sensor is implemented with substantially the same type of additional circuit as disclosed in Patent Document 1 in order to cause the gyro sensor to have a function of checking its own state, the size of the gyro sensor may be increased.

It is therefore an object of the present disclosure to provide a gyro sensor, which can suppress an increase in a size of the gyro sensor while the gyro sensor having a function of checking a state of the gyro sensor itself.

A gyro sensor according to an aspect of the present disclosure includes a gyro element, and a control unit electrically connected to the gyro element. The gyro element includes: a first port to which a drive signal for vibrating the gyro element is applied: a second port of outputting a drive sense signal in accordance with the drive signal; and a third port of outputting a detection signal in accordance with Coriolis force generated at the gyro element. The control unit includes a drive controller and a signal processor. The drive controller is connected to the first port and the second port. The drive controller is configured to generate the drive signal to input to the first port the drive signal generated. The drive controller is further configured to feedback-control the drive signal based on the drive sense signal output from the second port. The signal processor is connected to the third port. The signal processor is configured to perform signal processing relating to the detection signal output from the third port. The signal processor includes: an analog processor to which the detection signal is input: an A/D converter configured to convert, into a digital signal, a signal output from the analog processor: a digital calculator configured to generate an angular velocity signal based on the digital signal output from the A/D converter; and a checker. The analog processor is configured to selectively output either a detection component or a quadrature component to the A/D converter. The detection component and the quadrature component are included in the detection signal. The checker is configured to check a state relating to the control unit based on a first output signal or a second output signal. The first output signal is output from the A/D converter in response to that the quadrature component is input to the A/D converter. The second output signal is output from the digital calculator in response to that the first output signal is input to the digital calculator.

### BRIEF DESCRIPTION OF DRAWINGS

FIG. 1 is a functional block diagram showing a logical configuration of a gyro sensor according to an exemplary embodiment;

FIG. 2 is a flowchart for explaining how the gyro sensor operates:

FIG. 3 is a flowchart for explaining operation related to self-diagnosis in the gyro sensor:

FIG. 4 is a flowchart for explaining operation related to angular velocity calculation in the gyro sensor; and

FIG. 5 is a functional block diagram showing a logical configuration of an essential part in a variation of the gyro sensor.

### DESCRIPTION OF EMBODIMENTS

### Embodiment

Hereinafter, a gyro sensor according to this embodiment will be described with reference to the drawings. Note that the embodiment described in the following is only an exemplary one of various embodiments of the present disclosure and should not be construed as limiting. In the embodiment described in the following, various modifications may be made depending on a design choice or any other factor, as long as the purpose of the present disclosure is achieved.

### (1) Gyro Sensor

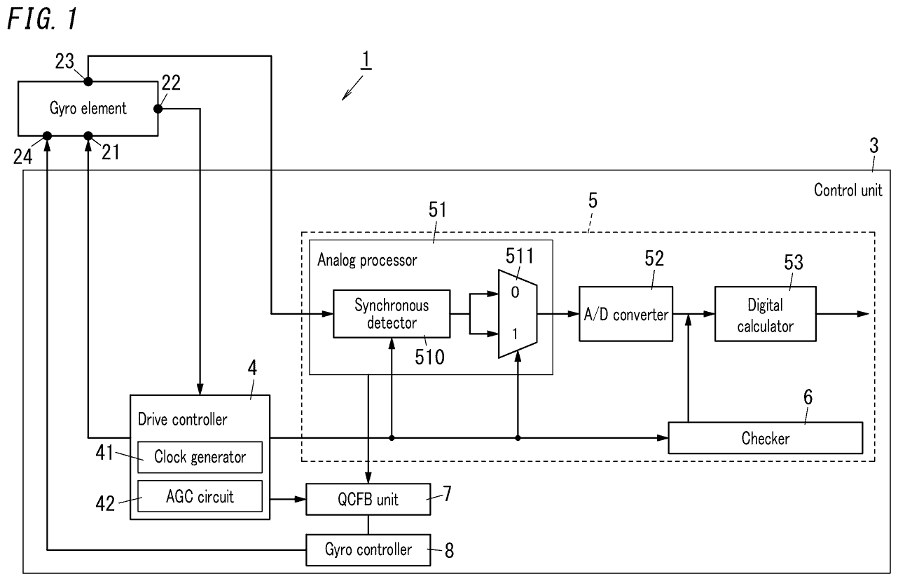

FIG. 1 is a block diagram illustrating a logical configuration of a gyro sensor 1 according to this embodiment. In this embodiment, as an example, the gyro sensor 1 is assumed to be a vibration type of one-axial gyro sensor. The gyro sensor 1 includes a gyro element 2, and a control unit 3 electrically connected to the gyro element 2.

### (2) Gyro Element

The gyro element 2 is an angular velocity detection element for detecting an angular velocity around a z-axis (detection axis) in three axes of x, y and z. The gyro element 2 is, for example, a resonator constituted by so-called Micro Electro Mechanical Systems (MEMS). The gyro element 2 includes, for example, a vibrating electrode and a detection electrode. The vibrating electrode vibrates in a direction of an x-axis (first direction) perpendicular to the z-axis (detection axis). The detection electrode detects, using a capacitance, movement of the vibrating electrode in accordance with Coriolis force (deflecting force) in a direction of a y-axis (second direction) perpendicular to both of the z-axis (detection axis) and the x-axis. That is to say, the detection method is, for example, a capacitance method. The structure of the gyro element 2 is not limited to the above-described structure, but the gyro element 2 may have any other structure, as long as it can detect the angular velocity around the detection axis. Alternatively, the detection method may be, for example, a piezoelectric method.

The gyro element 2 includes: a first port 21 (drive port) to which a drive signal for vibrating the gyro element 2 is applied: a second port 22 (monitor port) of outputting a drive sense signal in accordance with the drive signal; and a third port 23 (detection port) of outputting a detection signal in accordance with the Coriolis force generated at the gyro element 2. The gyro element 2 further includes a correction port 24 to which a correction signal for canceling a quadrature described later is applied.

### (3) Control Unit

The control unit 3 is, for example, a single Application Specific Integrated Circuit (ASIC). The control unit 3 is not limited to the single ASIC but may be a circuit including one or more IC, or may be a microcomputer.

As shown in FIG. 1, the control unit 3 includes a drive controller 4, and a signal processor 5. The control unit 3 further includes a Quadrature Cancel Feedback unit 7 (hereinafter, it will be referred to as the “QCFB unit 7”), and a gyro controller 8. The control unit 3 further includes a control circuit for maintaining a state in which a resonance frequency of a drive system (drive signal) and a resonance frequency of a detection system (detection signal) are matched with each other (mode matching). The control unit 3 further includes a thermal sensor detecting a temperature of the gyro sensor 1, and the temperature is used to perform temperature compensation related to the detection signal. The control unit 3 further includes: a First-in First-Out (FIFO) storage unit: a FIFO control unit configured to control storing information in the FIFO storage unit or reading out information from the FIFO storage unit: a communications circuit for communicating with an external device; and any other elements.

The drive controller 4 is configured to perform drive control of the gyro element 2. The drive controller 4 is connected to the first port 21 and the second port 22.

The drive controller 4 includes a clock generator 41 (oscillation circuit), and an Automatic Gain Control (AGC) circuit 42. The clock generator 41 generates a clock signal based on a signal output from a crystal oscillator or any other element. The drive controller 4 generates, in synchronization with the clock signal generated by the clock generator 41, the drive signal (drive voltage) for exciting the gyro element 2 in the direction of the x-axis. The drive controller 4 is configured to generate the drive signal to input to the first port 21 the drive signal generated, and feedback-control the drive signal based on the drive sense signal output from the second port 22. The drive sense signal, which is output from the second port 22 of the gyro element 2 to the drive controller 4, has a resonance frequency of the gyro element 2. The drive sense signal is input to the AGC circuit 42. The AGC circuit 42 input, into the first port 21 of the gyro element 2, the drive signal automatically gain-controlled so that the amplitude of the drive sense signal is constant.

The signal processor 5 is connected to the third port 23. The signal processor 5 is configured to perform signal processing relating to the detection (sense) signal output from the third port 23.

As shown in FIG. 1, the signal processor 5 includes an analog processor 51, an Analog-to-Digital (A/D) converter 52, a digital calculator 53, and a checker 6.

The analog processor 51 has an input end connected to the third port 23 of the gyro element 2. The detection signal (detection voltage) is input to the input end of the analog processor 51. The analog processor 51 includes a synchronous detector 510, and a switch unit 511.

The synchronous detector 510 is electrically connected to the drive controller 4. The synchronous detector 510 receives the drive signal from the drive controller 4, then generates a reference signal based on the drive signal, and then performs synchronous detection to extract a signal of a detection component corresponding to the Coriolis force, included in the detection signal (hereinafter, the detection component will be sometimes referred to as the “sense component”).

In response to that the gyro element 2 is subjected to the rotation around the z-axis (i.e., input of the angular velocity), usually, not only a moving component in the direction of the y-axis in accordance with the Coriolis force but also a moving component shifted in the direction of the x-axis are generated due to the structural manufacturing error (i.e., asymmetry) of the MEMS. Consequently, the detection signal includes not only the sense component in accordance with the Coriolis force in the direction of the y-axis (second direction) but also a quadrature component, i.e., a quadrature biasing error (Quadrature Error).

While the phase of the sense component in accordance with the Coriolis force is not shifted with respect to the phase of the drive signal, the phase of the quadrature component is shifted by 90 degrees with respect to the phase of the drive signal. In other words, the phase of the quadrature component is shifted by 90 degrees with respect to the phase of the sense component in accordance with the Coriolis force.

The presence of the quadrature component may contribute to a decrease in the sense accuracy of the angular velocity in the gyro sensor 1. To solve the issue, the gyro sensor 1 in this embodiment is provided with the QCFB unit 7. The QCFB unit 7 receives the drive signal from the drive controller 4 and further receives the detection signal from the synchronous detector 510 to extract the signal of the quadrature component, and outputs a signal for canceling the signal of the quadrature component to the gyro controller 8.

More specifically, for example, the QCFB unit 7 includes a phase shifter, a demodulator, an amplifier, a SAR_ADC, a controller and any other elements. The drive signal from the drive controller 4 and the detection signal from the synchronous detector 510 are input to the phase shifter and the demodulator, thereby a signal having an antiphase with respect to the signal of the quadrature component being generated. The signal having the antiphase is amplified by the amplifier, converted into a DC voltage signal by the SAR_ADC, and outputted from the controller of the QCFB unit 7 to the gyro controller 8.

The gyro controller 8 is connected to the correction port 24. The gyro controller 8 generates the correction signal based on the DC voltage signal received from the QCFB unit 7, and then applies the correction signal generated into the gyro element 2 via the correction port 24. The gyro controller 8 applies the correction signal to, for example, an electrode of the gyro element 2, which is provided for correction, to generate a force applied in a direction opposite to the moving component, shifted in the direction of the x-axis due to the structural manufacturing error of the MEMS, of the vibrating electrode of the gyro element 2, so that the force generated physically removes (cancels) the moving component shifted.

However, even with the function of the QCFB unit 7, the quadrature component is not completely removed from the detection signal. That is to say, the detection signal includes a small quadrature component stably existing.

Thus, the gyro sensor 1 in the present disclosure is configured to utilize, for diagnosis related to a state of the gyro sensor 1 itself, the quadrature component which is originally not required and should be removed when detecting the angular velocity. That is to say, the detection component (sense component) and the quadrature component are included in the detection signal, and the analog processor 51 is configured to selectively output either the detection component or the quadrature component to the A/D converter 52. More specifically, the synchronous detector 510 has a multiplier. The synchronous detector 510 causes the multiplier to multiply the detection signal by the reference signal for synchronous detection, generated based on the drive signal output from the drive controller 4. As a result, the synchronous detector 510 detects (extracts): a signal depending on the quadrature component (hereinafter, referred to as the “first component signal”); and a signal depending on the detection component (sense component) corresponding to the Coriolis force (hereinafter, referred to as the “second component signal”). The first component signal is an offset signal which appears depending on a phase shift, with respect to the reference signal, of the small quadrature component stably existing, even after the cancellation of the quadrature is performed by the QCFB unit 7. Originally, the synchronous detection is performed for removing unnecessary components (the quadrature component and any other components) other than the sense component corresponding to the Coriolis force, but in the present disclosure, the quadrature component is intentionally output to a post-stage circuit without removing the quadrature component.

Thus, the analog processor 51 receives, as the reference signal, the drive signal from the drive controller 4 and selectively outputs, based on the reference signal, either the detection component (sense component) or the quadrature component, included in the detection signal.

The synchronous detector 510, based on the reference signal, detects the second component signal corresponding to the Coriolis force at a phase timing of 180 degrees, and also detects the first component signal corresponding to the quadrature at a phase timing of 90 degrees. The first and second component signals detected are input to the switch unit 511.

As one example, the gyro sensor 1 in this embodiment is configured to be maintained in controlling (so-called mode matching) that the resonance frequency of the drive system and the resonance frequency of the detection system are matched with each other. The phase timings of the synchronous detection described above are merely one example in the case of the mode matching and should not be construed as limiting. In the case of controlling (so-called, non-mode matching) that the resonance frequency of the drive system and the resonance frequency of the detection system are NOT matched with each other, the synchronous detection may be performed at timings different from the phase timings described above.

The switch unit 511 is implemented as, for example, a multiplexer. The drive controller 4 switches, based on the phase timing of the drive signal (reference signal) to be output by the drive controller 4 itself, an input value sequentially between “0” corresponding to the phase timing of 90 degrees and “1” corresponding to the phase timing of 180 degrees. The drive controller 4 inputs an electrical signal including the input value to the switch unit 511. In response to whether the input value is “0” or “1,” the switch unit 511 switches a signal to be outputted to the A/D converter 52. For example, when the input value is “0,” the switch unit 511 outputs the first component signal corresponding to the quadrature. For example, when the input value is “1,” the switch unit 511 outputs the second component signal corresponding to the Coriolis force.

In short, the analog processor 51 outputs the first and second component signals to the subsequent A/D converter 52 by time division.

The A/D converter 52 configured to convert, into a digital signal, a signal output from the analog processor 51. More specifically, the A/D converter 52 converts, into a digital format signal, an analog format signal (i.e., the first component signal or the second component signal) output from the switch unit 511, and outputs the digital format signal to the digital calculator 53.

In this embodiment, the first component signal, out of the digital format first and second component signals output from the A/D converter 52, is a target signal (corresponding to a first output signal) to be checked by the checker 6 to be described later.

The digital calculator 53 is configured to generate an angular velocity signal based on the digital signal output from the A/D converter 52. More specifically, the digital calculator 53 includes, for example, a Low Pass Filter (LPF) processor. The digital calculator 53 causes the LPF processor to remove or reduce a component(s) of a frequency band, which is higher than a desired frequency band, from the digital format second component signal output from the A/D converter 52 to extract a signal of the desired frequency band. The digital calculator 53 performs gain adjustment and offset adjustment for the signal extracted, and also performs compensation processing (e.g., temperature compensation processing using the temperature value detected by the thermal sensor) to calculate an average value of the angular velocity per unit time, for example. The digital calculator 53 generates the angular velocity signal including the average value of the angular velocity. The digital calculator 53 outputs the angular velocity signal generated.

For example, the angular velocity signal may be output to a presentation device (user interface) or any other device through the FIFO storage unit and the communications circuit, which are disposed at a subsequent stage of the digital calculator 53. The presentation device may present information about the angular velocity to the user.

The digital calculator 53 may discard, as an unwanted signal, the digital format first component signal corresponding to the quadrature, received from the A/D converter 52, without performing calculation processing for the digital format first component signal.

The checker 6 is configured to check a state relating to the control unit 3 based on a first output signal, which is output from the A/D converter 52 in response to that the quadrature component is input to the A/D converter 52. In this embodiment, the checker 6 sets, as a check target, the first output signal output from the A/D converter 52 as described above. The checker 6 receives the input value, input to the switch unit 511 by the drive controller 4, to determines whether the first output signal is the first component signal or the second component signal.

In this embodiment, the “state” relating to the control unit 3 is assumed to be, as one example, a malfunction state of the control unit 3. Electronic components of the control unit 3 may deteriorate or be damaged due to aging degradation or impact received externally. Or disconnection in a circuit of the control unit 3 may occur due to the aging degradation or the impact. The control unit 3 therefore may fall into a state (malfunction state) where it cannot normally perform signal processing. The “state” relating to the control unit 3 may be a symptom state before it falls into the malfunction.

The checker 6 monitors the first output signal to perform a check (diagnosis) for the presence or absence of the malfunction. In particular, the checker 6 monitors the first output signal, for example, while the gyro sensor 1 receives the rotation about the z-axis.

The checker 6 includes a processing circuit that performs arithmetic processing for comparing a signal value (voltage value) of the first output signal to a prescribed range. In this embodiment, the checker 6 is configured to make a decision that the malfunction is present in the control unit 3, when finding that the signal value of the first output signal deviates from the prescribed range at least one time within a predetermined time period (satisfaction of a first abnormal condition). That is to say, the checker 6 determines whether the signal value of the first output signal is within or outside the prescribed range.

If the malfunction is absent in the control unit 3, while the gyro sensor 1 receives the rotation about the z-axis, basically, the first output signal is output stably to an extent that the signal value is greater than or equal to a first threshold but does not exceed a second threshold which is set greater than the first threshold (that is to say, in a manner that the signal value falls within the prescribed range). On the other hand, if the malfunction is present in the control unit 3, the first output signal is likely to be output in a manner that the signal value deviates from the prescribed range.

However, if the gyro sensor 1 is subjected to a transient impact or vibration even in case that the malfunction is absent in the control unit 3, the signal value of the first output signal may instantaneously exceed the second threshold (that is to say, the signal value may instantaneously deviate from the prescribed range. Thus, in order to reduce possibility of wrong decision due to the transient impact or vibration, the checker 6 is preferably configured to make a decision that the malfunction is present, when finding that the signal value deviates from the prescribed range two or more times within the predetermined time period.

Alternatively, the checker 6 may be configured to make a decision that the malfunction is present in the control unit 3, when finding that a specific situation continues over a fixed time (satisfaction of a second abnormal condition). In this case, the specific situation is that the signal value of the first output signal deviates from the prescribed range.

The signal value of the first output signal is not limited to an instantaneous value but may be a representative value, such as an average value, a maximum value, a minimum value, or a median value of signal values within a specified time period.

At least one of the first and second abnormal conditions described above is set, which can improve the reliability relating to the decision result of the checker 6. The first and second abnormal conditions are merely examples and are not limited thereto. The checker 6 may make the malfunction decision by using the first and second abnormal conditions in a combined manner. The prescribed ranges for the first and second abnormal conditions may be different from each other.

When the checker 6 is configured to check the symptom state before the malfunction, the checker 6 preferably determines whether or not it is in the symptom state based on a higher sensitivity condition than the first and second abnormal conditions using the prescribed range. In this case, for example, a lower threshold may be set as the second threshold.

In this embodiment, the first output signal is used as the check target, which can realize diagnosis of the malfunction occurring at the analog processor 51 and the A/D converter 52 in the control unit 3 (in particular, diagnosis of the malfunction occurring at the A/D converter 52).

When the checking result indicates that the malfunction is present, the checker 6 is configured to output information about presence of the malfunction. For example, when the signal value of the first output signal is abnormal (i.e., when the first abnormal condition is satisfied), the checker 6 outputs a reporting signal for externally reporting the presence of the malfunction. The reporting signal is transmitted to the presentation device (user interface) via the communications circuit. The checker 6 may output not only the information about presence of the malfunction but also information indicating that it is normal (no malfunction). Thus, the reporting signal is output, and therefore the user's side can know the result of the self-diagnosis performed by the gyro sensor 1.

### (4) Operation

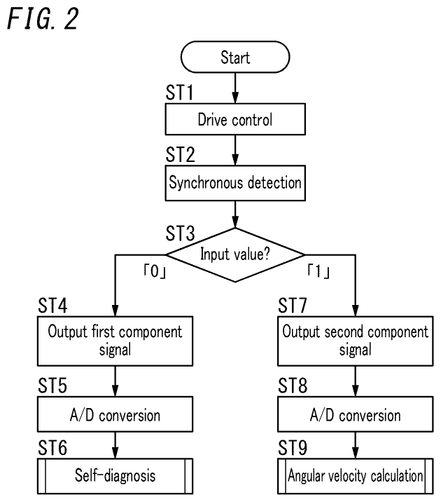

Hereinafter, a series of steps about how the gyro sensor 1 operates will be described with reference to FIG. 2. A flowchart shown in FIG. 2 is merely one example of an operation flow according to this disclosure, and the order of some processes may be changed as appropriate, or at least one process may be added or omitted as appropriate.

When the gyro sensor 1 starts operation, the drive controller 4 performs the drive control of the gyro element 2 so as to detect the angular velocity around the z-axis (in step ST1).

In the gyro sensor 1, the synchronous detector 510 of the analog processor 51 performs the synchronous detection processing on the detection signal to detect the first component signal depending on the quadrature component and the second component signal depending on the sense component (in step ST2). In the gyro sensor 1, when the quadrature component is included in the detection signal in accordance with the occurrence of the rotation about the z-axis, the QCFB unit 7 performs the canceling of the quadrature component.

The gyro sensor 1 selectively switches the signal to be outputted in accordance with the input value with respect to the switch unit 511 (in step ST3).

In the gyro sensor 1, when the input value is “0” (the answer in step ST3 is “0”), the switch unit 511 outputs the first component signal depending on the quadrature component (in step ST4). The first component signal is converted into the digital format by the A/D converter 52 (in step ST5), and then the self-diagnosis processing based on the first component signal is performed by the checker 6 (in step ST6).

On the other hand, in the gyro sensor 1, when the input value is “1” (the answer in step ST3 is “1”), the switch unit 511 outputs the second component signal depending on the sense component (in step ST7). The second component signal is converted into the digital format by the A/D converter 52 (in step ST8), and then the angular velocity is calculated based on the second component signal by the digital calculator 53 (in step ST9).

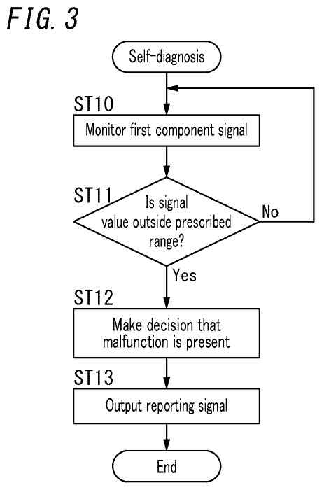

Next, a series of steps about operation related to the self-diagnosis of the gyro sensor 1 will be described with reference to FIG. 3. A flowchart shown in FIG. 3 is merely one example of the operation flow related to the self-diagnosis according to this disclosure, and the order of some processes may be changed as appropriate, or at least one process may be added or omitted as appropriate.

In the gyro sensor 1, the checker 6 monitors the first component signal (i.e., the first output signal) output from the A/D converter 52 (in step ST10). In the gyro sensor 1, the checker 6 checks whether or not the signal value of the first component signal deviates from the prescribed range, for example, two or more times within the predetermined time period (in step ST11). If the signal value deviates from the prescribed range two or more times within the predetermined time period (the answer in step ST11 is “Yes”), the gyro sensor 1 makes a decision that the malfunction is present in the control unit 3 (in step ST12). The gyro sensor 1 continues the monitoring unless the signal value deviates from the prescribed range two or more times within the predetermined time period (the answer in step ST11 is “No”).

When making the decision that the malfunction is present, the gyro sensor 1 outputs the reporting signal to externally report the information about the presence of the malfunction (in step ST13).

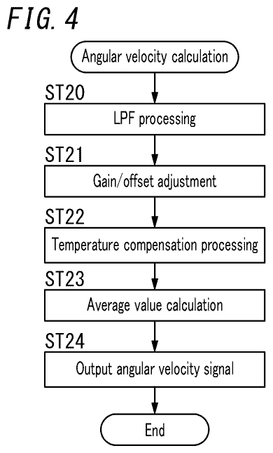

Next, a series of steps about operation related to the angular velocity calculation of the gyro sensor 1 will be described with reference to FIG. 4. A flowchart shown in FIG. 4 is merely one example of the operation flow related to the angular velocity calculation according to this disclosure, and the order of some processes may be changed as appropriate, or at least one process may be added or omitted as appropriate.

In the gyro sensor 1, the digital calculator 53 extracts, using the LPF processor, the signal of the desired frequency band from the second component signal output from the A/D converter 52 (in step ST20). In the gyro sensor 1, the digital calculator 53 performs the gain adjustment, and the offset adjustment for the signal extracted (in step ST21). In the gyro sensor 1, the digital calculator 53 then performs the temperature compensation processing (in step ST22). In the gyro sensor 1, the digital calculator 53 then calculates the average value of the angular velocity (in step ST23). In the gyro sensor 1, the digital calculator 53 then generates and outputs the angular velocity signal (in step ST24). As a result, for example, information about the angular velocity is presented in real time from the user's presentation device.

### (5) Advantages

As described above, the gyro sensor 1 according to this embodiment includes the checker 6. The checker 6 checks the state (e.g., malfunction state) relating to the control unit 3 based on the first output signal (including the quadrature component) output from the A/D converter 52. Therefore, the gyro sensor 1 is not needed to be implemented with substantially the same type of additional circuit as disclosed in Patent Document 1. As a result, the gyro sensor 1 has an advantage that it can suppress an increase in a size of the gyro sensor while having a function of checking a state of the gyro sensor itself.

In particular, the A/D converter 52 is likely to be a relatively large circuitry. If the same type of another A/D converter 52 is additionally implemented to check the state relating to the A/D converter 52, the increase in the size of the gyro sensor 1 is inevitable. Even considering this point, the gyro sensor 1 according to this embodiment can suppress the increase in the size of the gyro sensor.

Furthermore, in the gyro sensor 1 according to this embodiment, the second component signal depending on the sense component is also inputted, separately from the first component signal depending on the quadrature component, to the digital calculator 53, thereby the angular velocity being calculated. Therefore, the function of self-diagnosis can be provided, while the sense accuracy of the angular velocity is not reduced.

Also, since the checker 6 outputs the information about the presence of the malfunction, for example, the user's side can report the information about the presence of the malfunction. The convenience is therefore improved.

### (Variation)

Hereinafter, variations according to the embodiment will be listed. Each of the following variations may be realized in appropriate combination with the embodiment described above, or other variations.

In the gyro sensor 1, as long as the quadrature component is included in the detection signal, the function of the QCFB unit 7 is not essential. That is to say, the function of physically canceling the moving component due to the manufacturing error of MEMS is not essential.

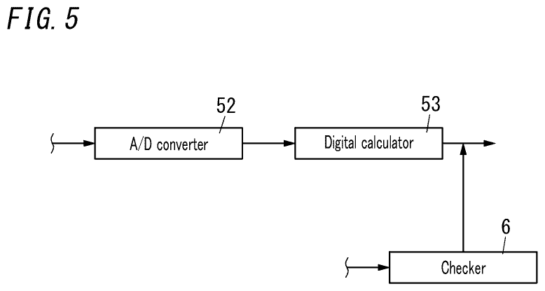

In the above-described embodiment, the first component signal (the first output signal) output from the A/D converter 52 is the target signal to be checked by the checker 6. However, the target signal to be checked by the checker 6 is not limited to the first component signal output from the A/D converter 52. For example, as shown in FIG. 5, the signal (second output signal) output from the digital calculator 53 may be the target signal to be checked by the checker 6.

In other words, the checker 6 may be configured to check the state relating to the control unit 3 based on the second output signal output from the digital calculator 53 in response to that the first output signal is input to the digital calculator 53. When the second output signal is set as the target signal to be checked, the above-mentioned state (malfunction state) may also include a malfunction of the digital calculator 53. In short, it is also possible to check presence or absence of the malfunction of the digital calculator 53.

When the second output signal is set as the target signal to be checked, the digital calculator 53 may perform the signal processing without discarding the first component signal received. For example, similarly to the signal processing related to the second component signal, the digital calculator 53 performs the LPF processing, the gain adjustment and the offset adjustment for the first component signal received and performs the temperature compensation processing to calculate the average value of the signal values per unit-time. In this case, the FIFO control unit or the communication circuit, disposed at the subsequent stage of the digital calculator 53, may discard the signal including this unnecessary calculation result.

Even when the second output signal is set as the target signal to be checked, at least one of the first abnormal condition or the second abnormal condition described above is preferably set. The prescribed ranges to be respectively used in checking the first and second output signals may be set to be different from each other.

Alternatively, both of the first output signal and the second output signal may be the check targets to be checked by the checker 6. In this case, for example, when finding that the signal value of the first output signal is normal (i.e., the first abnormal condition is not satisfied) but the signal value of the second output signal is abnormal (i.e., the first abnormal condition is satisfied), the checker 6 may make a decision that the malfunction has occurred in the digital calculator 53. When the checker 6 can identify the occurrence site of the malfunction in this manner, the checker 6 may output the reporting signal including information about the occurrence site.

However, even if the malfunction has not occurred, the signal value of the second output signal output from the digital calculator 53 may be more hardly a stable value due to the influence of the use environment where the gyro sensor 1 is used or any other factor, as compared with the signal value of the first output signal. For that reason, as the check target, the first output signal is preferable to the second output signal.

In the embodiment described above, it is assumed that the gyro sensor 1 is implemented, where the gyro element 2 and the control unit 3 are integrally packaged. However, the gyro sensor 1 may be implemented, where at least some functions of the control unit 3 are provided in a housing separately from the gyro element 2. More specifically, for example, the gyro sensor 1 may be implemented, where all the functions of the control unit 3 are provided in a housing separately from the gyro element 2, or only the function of the checker 6 of the control unit 3 is provided in a housing separately from the gyro element 2 and the other functions of the control unit 3.

### (Recapitulation)

The following aspects are disclosed in the embodiment and the like described above. A gyro sensor (1) according to a first aspect includes a gyro element (2), and a control unit (3) electrically connected to the gyro element (2). The gyro element (2) includes: a first port (21) to which a drive signal for vibrating the gyro element (2) is applied: a second port (22) of outputting a drive sense signal in accordance with the drive signal; and a third port (23) of outputting a detection signal in accordance with Coriolis force generated at the gyro element (2). The control unit (3) includes a drive controller (4) and a signal processor (5). The drive controller (4) is connected to the first port (21) and the second port (22). The drive controller (4) is configured to generate the drive signal to input to the first port (21) the drive signal generated. The drive controller (4) is further configured to feedback-control the drive signal based on the drive sense signal output from the second port (22). The signal processor (5) is connected to the third port (23). The signal processor (5) is configured to perform signal processing relating to the detection signal output from the third port (23). The signal processor (5) includes: an analog processor (51) to which the detection signal is input: an A/D converter (52) configured to convert, into a digital signal, a signal output from the analog processor (51): a digital calculator (53) configured to generate an angular velocity signal based on the digital signal output from the A/D converter (52); and a checker (6). The analog processor (51) is configured to selectively output either a detection component or a quadrature component to the A/D converter (52). The detection component and the quadrature component are included in the detection signal. The checker (6) is configured to check a state relating to the control unit (3) based on a first output signal or a second output signal. The first output signal is output from the A/D converter (52) in response to that the quadrature component is input to the A/D converter (52). The second output signal is output from the digital calculator (53) in response to that the first output signal is input to the digital calculator (53).

The above aspect has an advantage that the gyro sensor (1) can suppress an increase in a size of the gyro sensor (1) while having a function of checking a state of the gyro sensor (1) itself.

In a gyro sensor (1) according to a second aspect, which may be implemented in conjunction with the first aspect, the checker (6) is configured to make a decision that a malfunction is present in the control unit (3), when finding that a signal value of the first output signal or the second output signal deviates from a prescribed range at least one time within a predetermine time period.

According to the above aspect, the reliability relating to the decision result of the checker (6) can be improved.

In a gyro sensor (1) according to a third aspect, which may be implemented in conjunction with the first or second aspect, the checker (6) is configured to make a decision that a malfunction is present in the control unit (3), when finding that a specific situation continues over a fixed time. The specific situation is that a signal value of the first output signal or the second output signal deviates from a prescribed range.

According to the above aspect, the reliability relating to the decision result of the checker (6) can be improved.

In a gyro sensor (1) according to a fourth aspect, which may be implemented in conjunction with any one of the first to third aspects, the checker (6) is configured to output, when a checking result of the checker indicates that a malfunction is present, information about presence of the malfunction.

According to the above aspect, for example, the user's side can report the information about the presence of the malfunction.

In a gyro sensor (1) according to a fifth aspect, which may be implemented in conjunction with any one of the first to fourth aspects, the analog processor (51) is configured to: receive, as a reference signal, the drive signal from the drive controller (4); and selectively output, based on the reference signal, either the detection component or the quadrature component included in the detection signal.

According to the above aspect, the quadrature component can be output by synchronous detection based on the reference signal with higher accuracy.

Note that the constituent elements according to the second to fifth aspects are not essential constituent elements for the gyro sensor (1) but may be omitted as appropriate.

### REFERENCE SIGNS LIST

1 Gyro sensor
2 Gyro element
21 First port
22 Second port
23 Third port
3 Control unit
4 Drive controller
5 Signal processor
51 Analog processor
52 A/D converter
53 Digital calculator
6 Checker

1. A gyro sensor comprising:
a gyro element; and
a control unit electrically connected to the gyro element,
the gyro element including
a first port to which a drive signal for vibrating the gyro element is applied,
a second port of outputting a drive sense signal in accordance with the drive signal, and
a third port of outputting a detection signal in accordance with Coriolis force generated at the gyro element,
the control unit including
a drive controller connected to the first port and the second port, the drive controller being configured to generate the drive signal to input to the first port the drive signal generated, and the drive controller being further configured to feedback-control the drive signal based on the drive sense signal output from the second port, and
a signal processor connected to the third port, the signal processor being configured to perform signal processing relating to the detection signal output from the third port,
the signal processor including
an analog processor to which the detection signal is input,
an A/D converter configured to convert, into a digital signal, a signal output from the analog processor,
a digital calculator configured to generate an angular velocity signal based on the digital signal output from the A/D converter, and
a checker,
the analog processor being configured to selectively output either a detection component or a quadrature component to the A/D converter, the detection component and the quadrature component being included in the detection signal,
the checker being configured to check a state relating to the control unit based on a first output signal or a second output signal,
the first output signal being output from the A/D converter in response to that the quadrature component is input to the A/D converter, and
the second output signal being output from the digital calculator in response to that the first output signal is input to the digital calculator.

2. The gyro sensor of claim 1, wherein
the checker is configured to make a decision that a malfunction is present in the control unit, when finding that a signal value of the first output signal or the second output signal deviates from a prescribed range at least one time within a predetermine time period.

3. The gyro sensor of claim 1, wherein
the checker is configured to make a decision that a malfunction is present in the control unit, when finding that a specific situation continues over a fixed time, the specific situation being that a signal value of the first output signal or the second output signal deviates from a prescribed range.

4. The gyro sensor of claim 1, wherein
the checker is configured to output, when a checking result of the checker indicates that a malfunction is present, information about presence of the malfunction.

5. The gyro sensor of claim 1, wherein
the analog processor is configured to
receive, as a reference signal, the drive signal from the drive controller, and
selectively output, based on the reference signal, either the detection component or the quadrature component included in the detection signal.

6. The gyro sensor of claim 2, wherein
the analog processor is configured to
receive, as a reference signal, the drive signal from the drive controller, and
selectively output, based on the reference signal, either the detection component or the quadrature component included in the detection signal.

7. The gyro sensor of claim 3, wherein
the analog processor is configured to
receive, as a reference signal, the drive signal from the drive controller, and
selectively output, based on the reference signal, either the detection component or the quadrature component included in the detection signal.

8. The gyro sensor of claim 4, wherein
the analog processor is configured to
receive, as a reference signal, the drive signal from the drive controller, and
selectively output, based on the reference signal, either the detection component or the quadrature component included in the detection signal.
